(19) United States
(12) Patent Application Publication
(10) Pub. No.: US 2025/0269714 A1
(43) Pub. Date: Aug. 28, 2025

(54) METHOD FOR DIAGNOSING THE OPERATION OF AN ACTIVE AIR FLOW REGULATION SYSTEM

(71) Applicant: Sonceboz Motion Boncourt SA, Boncourt (CH)

(72) Inventors: Guillaume Callerant, Chavannes-sur-l'Etang (FR); Samuel Equoy, Baumeles-Dames (FR); Coline Lugaz, Ecublens VD (CH)

(21) Appl. No.: 18/858,665

(22) PCT Filed: Apr. 21, 2023
(86) PCT No.: PCT/EP2023/060486

§ 371 Date: Oct. 21, 2024

(30) Foreign Application Priority Data
Apr. 21, 2022 (FR) FR2203716

(51) Int. Cl. B60K 11/08

(52) U.S. Cl. CPC B60K 11/085; B60Y 2306/15

(57) ABSTRACT

An active air flow regulation system for diagnosing the operation of an active air flow regulation system for a vehicle comprises: an obstructing mechanical member; a mechatronic system having a housing containing a magnet motor driven by a control circuit and coupled to a movement transformation for moving the obstructing mechanical member; and electronic communication lines for exchanging information with the DCU of the vehicle or receiving commands from the DCU of the vehicle, A related method includes storing, during an operating cycle of the active air flow regulation system, a numerical sequence S of data in a memory, the data acquired by the control circuit inside the mechatronic system; applying an algorithmic statistical analysis model to the data stored in the memory to determine a singularity; and identifying a sporadic error associated with the singularity to provide information on the state of the active air flow regulation system.

### CROSS-REFERENCE TO RELATED APPLICATIONS

This application is a national phase entry under 35 U.S.C. § 371 of International Patent Application PCT/EP2023/060486, filed Apr. 21, 2023, designating the United States of America and published as International Patent Publication WO 2023/203219 A1 on Oct. 26, 2023, which claims the benefit under Article 8 of the Patent Cooperation Treaty of French Patent Application Serial No. FR2203716, filed Apr. 21, 2022.

### TECHNICAL FIELD

The present disclosure relates to the field of active air flow regulation of a vehicle and, in particular, to the modification of the air penetration coefficient of a vehicle, through the use of motorized fins or spoilers, the thermal control of the vehicle, in particular, of the engine, a braking system and more generally any component actively regulated in temperature, in particular, a motor vehicle with an internal combustion engine or an electric or hybrid motor by active air flow regulation systems driving an obstructing member, for example, motorized air shutters on the grille or curtains. This obstructing member is designed to modify the quantity of air passing through the vehicle's radiator and engine compartment, and to adjust the air flow in order to manage the efficiency of the vehicle's engine and the various main aggregates (combustion engine, electric traction motor and its inverter, gearbox, battery pack, etc.). With the evolution of anti-pollution standards, engine temperature management has become a major area of development in engine design. Engine cooling is now optimized to control the temperature of the various engine zones while limiting energy consumption.

### BACKGROUND

The purpose of the thermal management circuit is to maintain the engine's various internal components (cylinders, cylinder head, etc.) and, where applicable, peripheral components (e.g., turbocharger) at their ideal operating temperature.

If the engine temperature is too high, the gases inside the cylinder are hotter, meaning less gas in the cylinder, and the risk of auto-ignition (and knocking) is greater. On the other hand, as the components deform more, there is a greater risk of breakage.

If, on the other hand, the engine is cold, friction between piston and cylinder liner is generally higher, and combustion is incomplete, resulting in significantly higher emissions of pollutants.

On many recent vehicles, the fins of the grille in front of the radiator are hinged and motorized to control the flow of air through the radiator. In fact, when the vehicle is traveling at high speed and low load, a high air flow is not necessarily essential to properly cool the engine.

In addition, the air flowing through the radiator disturbs the main flow around the vehicle, generating aerodynamic drag. It can also be advantageous to block air intakes upstream of the radiator with shutters. In some cases, the shutters have only two positions (fully open or closed).

Unfortunately, the CO₂ emission reduction benefits of these active shutter calenders are lost if a shutter remains locked in an open or closed position, or in an intermediate position, or if it suffers damage, e.g., in the event of an impact, or if one or more shutters are missing. The correct operation of an active shutter grille has an impact on the vehicle's pollutant emissions. It is, therefore, of the utmost importance, and even legally mandatory, to ensure the correct operation of the air shutter device, and to inform the driver of any deterioration in the vehicle's fuel consumption and pollution levels each time the vehicle is driven, prompting him or her to make a quick trip to the garage to restore the vehicle's legal emission level. To this end, solutions have been provided for checking the generic functionality of the air shutter arrangement by means of an on-board diagnostic system. For electric vehicles, thermal control of the motor and batteries is also an important issue, with the same requirements, as is aerodynamic efficiency: a faulty active air flow regulation system could penalize the vehicle's air penetration and, therefore, have a negative impact on the vehicle's range.

Various solutions are known in the prior art to meet this objective of detecting a malfunction in the active shutters of a grille.

DE102018108162 describes an actuator control method and an actuator wherein a DC motor drives a system to move a first body relative to a second body, the first body sliding along a contact surface of the second body. The principle of this solution is based on current analysis to assess the actuator's behavior by providing areas of modified mechanical resistance on the contact surface between the roller shutter and the guide rails.

This solution has several drawbacks.

First, it requires a specific reference zone on the regulation system, which is essential for detecting an anomaly using this prior art solution. Anomaly detection is strictly limited to detecting the anomaly in this reference zone, and in no way allows detection of anomalies in general in the mechanical and aeraulic transmission chain. This reference zone can also wear out, rendering signal evaluation inoperative.

Second, it is limited to mechatronic systems using DC motors, and cannot be implemented for systems using stepper motors; the use of torque (or DC current) measurement imposes closed-loop motor control, which is antinomic to stepper motor control, making prior art solutions unusable or difficult in this context.

Third, the signal analyzed is the current, which reflects the torque, transmitted to the computer. However, the update frequency of this information is of the order of 10 μs, whereas the transmission capacity of multiplexed LIN-type protocols is of the order of 100 ms, leading to incompatibility and insufficient bandwidth to transmit the necessary information. The transmission of all the information acquired is not adapted to the very limited bandwidth of the communication network for vehicle control electronics.

US2020300156 describes another anomaly detection system for an engine cooling water recirculation system comprising: a grille shutter capable of regulating a circulating air flow coming from the outside of a vehicle to the environment of an engine body, wherein four learned neural networks are stored, which are obtained by using at least five parameters comprised of an engine cooling water temperature at the time of engine start, an amount of air taken into the engine, an amount of fuel injected into the engine, an outside air temperature, and a vehicle speed as input parameters of the neural networks and using a measured value of the engine cooling water temperature as training data to learn weights for four states comprising a state where the grille shutter is closed and an air blown by the blower does not circulate through the air-conditioning use heater, a state where the grille shutter is opened and the air blown by the blower does not circulate through the air-conditioning use heater, a state where the grille shutter is closed and the air blown by the blower circulates through the air-conditioning use heater, and a state where the grille shutter is opened and the air blown by the blower circulates through the air-conditioning use heater. The engine cooling water temperature is estimated from among the five parameters using any of the learned neural networks corresponding to a current state of the grille shutter and to the state of circulation of the air blown by the blower in the air-conditioning use heater from among the four learned neural networks. An engine cooling water recirculation system fault is detected on the basis of an estimated engine cooling water temperature value.

The disadvantage of this solution is that it provides information relating to the prediction of the temperature of the cooling water, which does not allow us to characterize an anomaly in the kinematic and aeraulic chain of the shut-off system.

In addition, this solution requires the deployment of four neural networks and, therefore, involves extremely complex processing.

DE10201201469 describes an air shutter device also having an adjustment drive, which is connected to the at least one air shutter in a movement and force-transmitting manner in order to adjust the at least one air shutter between its predetermined operating positions, the air shutter device also having a control device coupled to the adjustment drive in terms of signal transmission, a control device connected to the control device, a storage device coupled in terms of signal transmission and a data acquisition device that captures operating data from the air shutter device memory device, wherein a difference in operating positions representing a set of reference operating data is stored in the memory device.

US213338870 describes another system solution and a method for diagnosing a mechanical fault affecting an automotive Active Grille Shutter (AGS) system. The method involves receiving at least one mechanical fault status signal (410), such a signal indicating that a particular mechanical fault condition has been detected in the AGS system. The method also involves receiving a temperature signal (418) indicating a temperature at a location close to the grille shutter of the AGS system, and determining whether to carry out extended diagnostics, at least on the basis of the mechanical fault status signal and the temperature signal.

The prior art solutions are unable to reliably characterize an anomaly in the state of the mechanical and aeraulic shut-off chain, without any mechanical modification of this mechanical and aeraulic chain, such as deformation of a shutter or partial breakage of the air inlet system.

### BRIEF SUMMARY

In order to overcome these disadvantages and to provide a diagnostic function for the complete system without modifying the obstructing member, to characterize an air flow malfunction, using data inside the mechatronic system mobilizing the obstructing member, or data generated by the obstructing member where applicable. To this end, the present disclosure relates in its most general sense to a method for diagnosing the operation of an active air flow regulation system for a vehicle, and to a system for performing such a method.

The system comprises:
an obstructing mechanical member,
a mechatronic system provided with a housing containing a magnet motor driven by a control circuit and coupled to a movement transformation for moving the obstructing mechanical member, and
electronic communication lines for exchanging information with the DCU of the vehicle or receiving commands from the DCU of the vehicle.

The method comprises a series of steps consisting of:
storing, during an operating cycle of the active air flow regulation system, a numerical sequence S of data in a memory, the data being acquired by the control circuit inside the mechatronic system,
applying an algorithmic statistical analysis model to the numerical sequence of data S stored in the memory in order to determine a singularity, and
identifying a sporadic error associated with the singularity in order to provide information on the state of the active air flow regulation system.

In one variant, the sporadic error identification step is performed by the control circuit, the control circuit transmitting information representative of the identified sporadic error to the DCU.

In another variant, the digital data sequence stored in the memory is:
preprocessing with a first processing frequency by the control circuit, and
post-processing, by the DCU/ECU of the vehicle with a second processing frequency lower than the first processing frequency, to complete the analysis and identify a sporadic error,
the data set pre-processed by the control circuit being transmitted to the DCU/ECU via the command lines.

In one embodiment, the digital data sequence S stored in memory comprises:
data of a first type, and
data of at least a second type different from the first type.

In a further embodiment, the method comprises as additional steps:
consolidation of the sporadic error following an instruction transmitted by the vehicle's DCU, resulting in a consolidated diagnostic status, and
transmission of the consolidated diagnostic status to the vehicle's DCU.

For the purposes of this patent, “ECU” means an “electronic control unit” controlling a specific vehicle function.

However, driving safety, enhanced comfort and infotainment functions lead to unsustainable system complexity-up to hundreds of ECUs per vehicle.

It has been known to use domain controllers (DCUs) as well, with the aim of centralizing via this DCU (domain controller), rather than using multiple ECUs. The rise of the automotive domain controller has particularly been driven by vehicle automation, which requires combining data from different sensors, high-speed processing, and must meet the most stringent safety requirements. It must also offer the possibility of continuous development of new features and functionalities throughout the life of the vehicle, via Over The Air (OTA) updates.

The disclosure will refer to an ECU or DCU indiscriminately, as the nature of the controller depends on the choice of computer architecture of the vehicle on which the disclosure is implemented.

In addition, the statistical analysis algorithm can be provided with a supervised, unsupervised or reinforcement learning sequence.

Alternatively, the statistical analysis algorithm can be equipped with a clustering selection method.

In one variant, the obstructing mechanical member is devoid of dedicated diagnostic elements external to the mechatronic system.

In a permitted variation, the digital data Si relates to the operation of the mechatronic system's magnet motor.

In an anticipated alternative, the digital data Si is a motor phase current measurement.

In this case, the digital data Si may be a measure of the rotor load angle of the magnet motor.

In one embodiment, the algorithmic model for statistical analysis to determine a singularity is provided with a comparison between the stored sequence of sampled digital data S and a reference data map.

In a second embodiment, the algorithmic model for statistical analysis to determine a singularity is provided with a detection of a singular point in the stored sequence of sampled digital data S.

In a third variant, the algorithmic model for statistical analysis to determine a singularity consists in subjecting the stored sequence of sampled digital data S to a model obtained by training a neural network from training data corresponding to the nominal operation of the obstructing mechanical member.

In all cases, a reference sequence of sampled digital data Sᵣ can be stored for each mechatronic system at the end of the assembly line.

In this case, the algorithmic model for statistical analysis can compare the sampled digital data sequence with the reference sequence of sampled digital data in order to detect a behavioral drift that may give rise to a degradation of the mechatronic system or that may validate a normal wear behavior of the system.

In one embodiment, the stored sequence of sampled digital data S is derived from an item of digital data dependent on mechanical load in the active grid system.

In this case, the identification of a singularity in the stored sequence of sampled digital data S can be enabled with knowledge of:
masses or inertia to be moved in the active grid system,
and/or mechanical friction in the system,
and/or the aeraulic load exerted on the system,
and/or system temperature.

For the purposes of this patent, a “singularity” is defined as a point or subset of points in the stored data sequence that differs from a reference sequence corresponding to nominal operation, by comparison with one or more prerecorded nominal data sequences, or by the difference between the signature of the data sequence and the signature of a nominal data sequence acquired during a preliminary learning phase, obtained by the same signature calculation function, or a singularity in the sense of a Gaussian statistic, or a point or set of points differing from the projection of the median curve formed by the preceding points significantly from the average of the fluctuations of the stored points in relation to the median curve, significantly being understood as “exceeding by at least 20% the amplitude of the fluctuations in normal or nominal operation.”

In particular, a distinction is made between data for which a signature (torque, current, position, etc.) is sought, and information stored in the internal memory of the mechatronic system and, in particular, in the volatile or non-volatile memory of the controller, such as temperature.

In one variant, the algorithmic model for statistical analysis to determine a singularity consists in subjecting the stored sequence of sampled digital data S to a model obtained by training a neural network from training data corresponding to the nominal operation of the obstructing mechanical member.

In a particular embodiment, a reference sequence of sampled digital data is stored for each mechatronic system at the end of the assembly line.

Advantageously, the algorithmic model for statistical analysis is able to compare the sampled digital data sequence with the reference sequence of sampled digital data so as to detect a behavioral drift.

In one embodiment, the stored sequence of sampled digital data Sis derived from an item of digital data dependent on mechanical load in the active grid system.

According to particular embodiments, the identification of a singularity in the stored sequence of sampled digital data Sis enabled with knowledge of:
masses or inertia to be moved in the active grid system,
and/or mechanical friction in the system,
and/or the aeraulic load exerted on the system,

The disclosure also relates to an electromechanical active air flow regulation system for a vehicle, comprising:
an obstructing mechanical member,
a mechatronic system provided with a housing containing a magnet motor driven by a control circuit and coupled to a movement transformation for moving the obstructing mechanical member,
electronic communication lines for exchanging information with the DCU of the vehicle or receiving commands from the DCU of the vehicle,

characterized in that the method comprises a microcontroller or microprocessor executing a computer program stored in its read-only memory, controlling a series of steps consisting of:
storing, during an operating cycle of the active air flow regulation system, a sequence of sampled digital data Sin a memory, wherein the sequence of sampled digital data is made up of a set of digital data, Si, acquired by the control circuit inside the mechatronic system,
applying an algorithmic statistical analysis model to the sequence of sampled digital data S stored in the memory in order to determine a singularity,
identifying by the control circuit and transmit to the DCU, a sporadic error associated with the singularity, being information on the state of the active air flow regulation system.

### BRIEF DESCRIPTION OF THE DRAWINGS

The present disclosure will be better understood on reading the description of different non-limiting embodiments that follows, with reference to the accompanying drawings, wherein:

FIG. 1 shows a schematic view of an active air flow regulation system driven by a stepper motor according to the disclosure;

FIG. 2 shows a schematic view of a variant of an active air flow regulation system driven by a sensored BLDC motor according to the disclosure;

FIG. 3 shows a schematic view of a variant of an active air flow regulation system driven by a sensorless BLDC motor according to the disclosure;

FIG. 4 shows an example of a diagnostic algorithm for fault identification dedicated to a shutter system;

FIG. 5 shows an example of a learning algorithm for fault recognition based on the algorithm presented in FIG. 4;

FIG. 6 shows an exploded view of an active shutter air regulation system;

FIG. 7 shows an exploded view of an active curtain air regulation system;

FIGS. 8 to 12 show various examples of malfunctions related to the system shown in FIG. 6;

FIGS. 13 to 16 show various examples of malfunctions related to the system shown in FIG. 7;

FIGS. 17A-17D show the Fresnel diagram of a three-phase motor, allowing the motor's load angle to be visualized;

FIG. 18 shows a method for acquiring a series of data acquisition, for identifying a singularity, based on a measurement of the power consumed by the motor; and

FIG. 19 shows an example of a supervised learning algorithm that can be used as a decision-making basis for the algorithm presented in FIG. 4.

### DETAILED DESCRIPTION

### General Principle of an Active Air Flow Regulation System

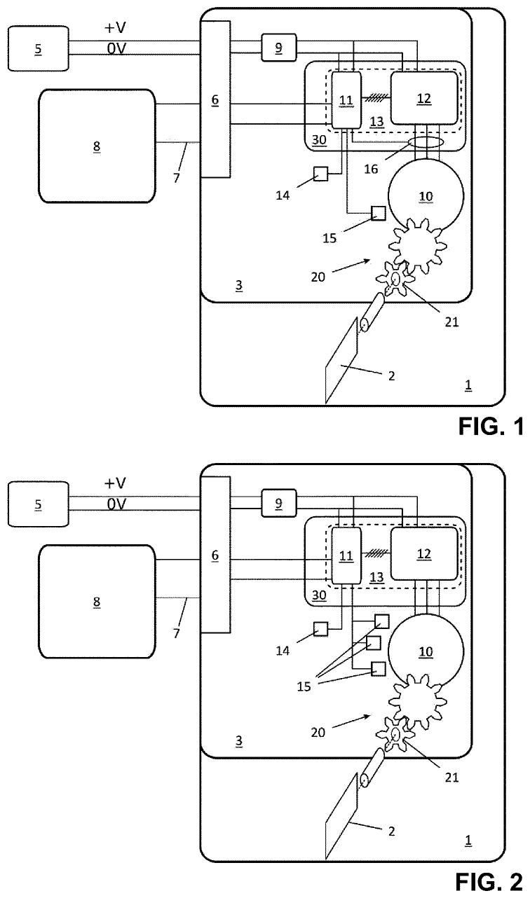

FIG. 1 shows a general view of an active air flow regulation system (1). This regulation system is composed of a mechanical obstructing member (2), which is positioned on the grille of the automobile and is able to obstruct the arrival of the air flow onto the radiator, and comprises a mechatronic system (3) controlling the positioning of the mechanical obstructing member (2), such as shutters or a roller, allowing the modulation of the air flow received by the radiator, depending on the state of the mechanical obstructing member (2).

The aim of the present disclosure is to automate the detection and characterization of an anomaly in the mechanical and/or aeraulic air flow regulation elements, in particular, the disappearance of a shutter, or the modification of the geometry of a shutter resulting, for example, from an impact, even if these anomalies do not modify the general kinematics of the mechatronic air flow regulation system. Of course, the disclosure also makes it possible to detect faults in the mechatronic air flow regulation system, such as blockage or seizure.

The mechatronic system (3) comprises a motion transmission chain (20) driven by a polyphase permanent magnet synchronous motor, hereinafter referred to as a magnet motor (10), controlled by an electronic control circuit (30), for example, a three-phase motor as shown in FIG. 1.

The present disclosure involves exploiting the signals available on the electronic control circuit (30) of the mechatronic system (3), without requiring the addition of one or more additional sensors on the obstructing mechanical member (2) of the active air flow regulation system (1), so that the mechatronic system (3) according to the disclosure can provide diagnostic information when integrated into an active air flow regulation system (1) initially lacking this functionality. However, when additional sensors are already implemented in the active air flow regulation system (1), for example, on the mechanical obstructing member (2), the disclosure can also use the signals from these sensors, provided they are processed by the electronic control circuit (30).

The case shown in FIG. 1 shows a configuration wherein the magnet motor (10) is stepper-driven. The mechatronic system (3) is equipped with:
an electrical connector (6) that receives the power supply (5) from the vehicle's DC power network,
electrical communication lines (7) consisting of commands from the vehicle's Domain Control Unit (DCU) (8) and information generated by the mechatronic system (3) itself and intended for the vehicle's DCU (8),
an electrical protection and filtering module (9) to comply with applicable electrical and electromagnetic standards,
a control circuit (11) provided with memories, such as a microcontroller, generating the vehicle communication, control functions and drive of the magnet motor (10) by association with a transistor drive module,
the magnet motor (10) generating the desired displacement and torque, ⋅ a polyphase inverter (12), preferentially two-phase or three-phase, consisting of MOSFET transistors supplying the magnet motor (10) with electrical power,
a motion transmission chain (20) for reducing or transforming the motion of the rotor of the magnet motor (10), the input stage of which is driven by the rotor of the magnet motor (10) and the output stage (21) of which is coupled to the obstructing mechanical member (2).

It is important to note that the control circuit (11), the transistor driver module and the polyphase inverter (12) can be integrated into a specific component like vibration sensor (13) known to the layman by the acronym SOC (System On Chip). Preferably, the data sequence is generated by combining at least two different types of information, which may be derived, without limitation, from the following elements:
one (or more) vibration sensors (13) measuring vibration levels of a moving subassembly, taking into account the context of the active air flow regulation system (1),
one (or more) temperature sensors (14) measuring the internal temperature of the mechatronic system (3) and enabling the local temperature of a region of the active air flow regulation system (1) to be deduced,
one (or more) position sensor(s) (15) measuring the continuous position of the rotor of the magnet motor (10) or of a movable element in the mechatronic system (3) and enabling the load angle of the magnet motor (10) to be reconstructed,
one (or more) electrical sensors (16) measuring one or more electrical quantities, such as voltages or currents, at the polyphase inverter (12) and which, when recombined, enable the load angle of the magnet motor (10) to be reconstructed.

Combining information from several sensor types can be advantageous when there is strong economic pressure on the components integrated in the actuator, for example, very basic control electronics or low-sensitivity sensors, which do not allow a singularity to be extracted from information from a single type of sensor. This singularity can nevertheless be isolated by the cooperation of weak signals, and is then identified in a sequence of sampled data resulting from the aggregation of data from sources of different types. However, this approach is not limiting, as once the economic pressure is removed, a more complex system can be envisaged, and the sporadic error can be extracted from a data sequence presenting information of a single type.

In the example shown in FIG. 1, a typical scenario can be described as follows. The control circuit (11) receives a movement instruction from the DCU (8), and then generates the appropriate driving sequence for the switches of the polyphase inverter (12) so as to generate the movement. The movement instruction from the DCU (8) can be a complete or partial opening or closing movement, or an absolute position of the stroke to be reached. The present disclosure involves acquiring a data sequence by the control circuit (11), storing it in the memory, analyzing it using digital processing capable of detecting a singularity and transmitting a sporadic error associated with this singularity to the DCU (8) via the communication lines (7).

The data sequence can be acquired for any movement, or episodically according to an instruction from the DCU (8) or control circuit (11).

The control circuit (11) is able to extract a singularity from this sequence of stored data using statistical processing of varying complexity, depending on the functional requirements stemming from the types of malfunction sought and the desired sensitivity. For example, a fault caused by sudden deterioration, such as the breakage of a shutter blocking the travel of the obstructing mechanical member (2), is much easier to detect than a gradual aging of the actuator leading to a slight deterioration in performance close to the minimum required. This singularity can, therefore, be the symptom of a wide variety of malfunctions, and requires the application of the appropriate processing algorithm to generate a sporadic error from this error for transmission to the DCU (8). “Sporadic error” means an error code that is intelligible to the DCU (8) and can signal a wide variety of malfunctions encountered by the actuator, such as, but not limited to, the loss of one of the moving elements, the disconnection of one of the moving elements from the motion transmission chain, the loss of several elements of the obstructing mechanical member (2), or the breakage of a part of the motion transmission chain (20).

As shown in FIG. 1, the mechatronic system (3) can integrate various internal sensors to generate the signals used by the control circuit (11). These sensors can be of various types, including a vibration sensor (13), a temperature sensor (14), a pressure sensor, or an analog or digital probe measuring the magnetic angle of the rotor. The disclosure can also take advantage of the combination of several signals to generate integrity diagnostics for the active air flow regulation system.

FIG. 2 shows an alternative implementation of an active air flow regulation system (1) according to the disclosure. This design differs from that shown in FIG. 1 in that the magnet motor (10) is controlled by a sensored BLDC system, that is the magnet motor (10) is equipped with direct or FOC closed-loop control with direct measurement of its rotor position. To this end, one or more position sensors (15) are provided to inform the microcontroller of the exact position of the rotor of the permanent magnet motor (10), itself generating the desired displacement and torque.

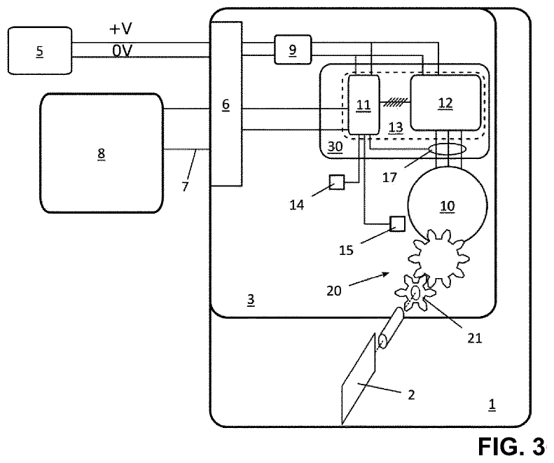

FIG. 3 shows a variant of an active air flow regulation system (1) according to the disclosure. This design differs from that shown in FIG. 2 in that the magnet motor (10) is sensorless BLDC, that is the rotor position information of the magnet motor (10) no longer comes from the position sensors (15) but is estimated from the electrical quantities measured at the terminals of the phase supply lines of the magnet motor (10), e.g., by means of a measuring device (17) for phase currents and/or voltages, which measuring device (17) can be equipped with one or more voltage and/or current sensors.

Of course, these are not the only ways of implementing the mechatronic system, and the person skilled in the art could easily imagine other alternatives for the design and control of the magnet motor, as well as for the content of the mechatronic system's internal sensors used to detect malfunctions.

Various types of malfunctions are illustrated in a number of examples, and various means of detecting these malfunctions are also presented, as are a number of solutions for extracting a singularity from the information provided by the detection means. Finally, several algorithmic implementations for converting the detected singularity into a tangible error signal are provided. The examples described are for illustrative purposes only and in no way limit the scope of the disclosure, as the person skilled in the art may use some or all of these examples and replace a missing brick with a solution known in the art.

### Detailed Description of a Variant of the Malfunction Detection Algorithm

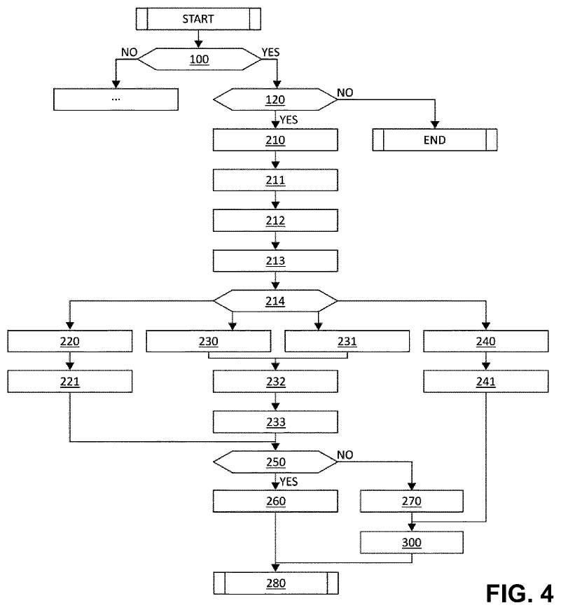

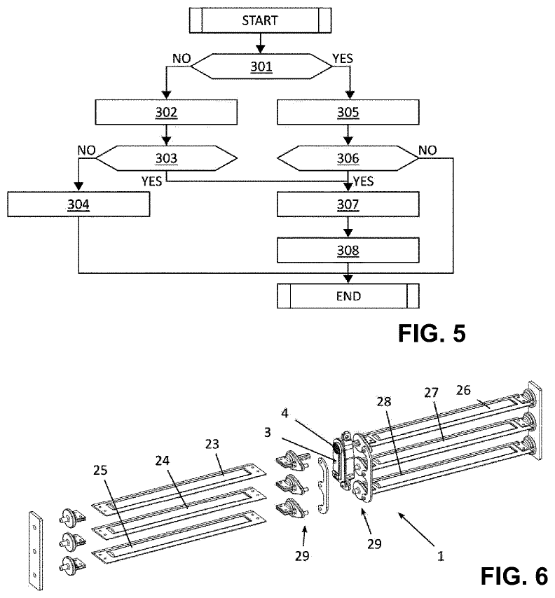

An example of an algorithm (200) describing fault diagnosis for an active air flow regulation system (1), whose obstructing mechanical member is a set of shutters, is represented by the flow chart given in FIG. 4. Following the successful completion of a single or cyclic learning phase (100), described in FIG. 5, this algorithm can be triggered on receipt of a request from the DCU (8), or automatically initiated when the actuator is set in motion by the DCU (8).

An optional step (120) upstream of this algorithm consists in obtaining authorization from the DCU (8) to carry out a diagnosis of the system status in the event of on-demand diagnosis, failing which, the diagnosis will be permanently activated during any movement carried out by the mechatronic system.

The first step (210) consists in initiating a movement phase of the obstructing mechanical member (2) generated by the mechatronic system (3). During this movement phase, the step (211) consists in acquiring a series of data s; by the control circuit (11). The storing of the data may relate to part or all of the movement of the obstructing member, and in any case ends at step (212), triggered by the end of the movement. The microcontroller then analyzes the stored s₁ data series using a dedicated algorithm to detect a singularity (213), which may be similar to a machine learning or deep learning model. This is followed by a step (214) for classifying the information resulting from the analysis of the data series sᵢ, giving rise to four possible outcomes:
a. No singularities were detected, so the system was classified as “nominal.” This is followed by a step (220) in which the mechatronic system (3) generates an operating code for the DCU (8), this code being associated, in a step (221), with the transmission of a confidence level of the previously performed classification (214) to the DCU (8).
b. A singularity corresponding to a degradation equivalent to the malfunctioning of a single active shutter was detected, so the system was classified as a “system with one degraded shutter.” This is followed by a step (230) in which a sporadic error code is generated by the mechatronic system (3) for the DCU (8), this code being associated in step (232) with the transmission of a confidence level of the previously performed classification in step (214), as well as with the transmission of the environmental context in step (233), in which the diagnosis, steps (210) to (214), has been performed.
c. A singularity corresponding to a degradation equivalent to the malfunctioning of several active shutters was detected, so the system was classified as a “system with significant degradation.” This is followed by a step (231) in which a sporadic error code is generated by the mechatronic system (3) for the DCU (8), this code being associated in step (232) with the transmission of a confidence level of the previously performed classification in step (214), as well as with the transmission of the environmental context in step (233), wherein the diagnosis, steps (210) to (214), has been performed.
d. The classification resulting from the analysis of the data series, carried out in step (214), did not allow us to converge on information with a sufficient level of confidence to be able to distribute it to the DCU (8). This is followed by a step (240) in which a code corresponding to the “non-availability” status of the diagnostic classification is generated and transferred by the mechatronic system (3) to the DCU (8), this code being associated in step (241) with the transmission to the DCU (8) of the environmental context wherein the diagnosis, steps (210) to (214), was carried out and was unable to converge.

The step (250), common to all classes providing tangible information, directs the user to step (260) if the confidence level is greater than or equal to a preset threshold, for example, 99.99%, depending on the confidence level generated in the previous steps. In step (260), a consolidated error code or a consolidated functional code is generated and transferred by the mechatronic system (3) to the DCU (8), which can be used to feed the OBD strategy. Alternatively, if the confidence level is below the preset threshold, step (250) is followed by a step (270) in which the mechatronic system recommends a strategy for consolidating the sporadic error, essentially consisting of one or more partial or complete actuator movements, to the DCU.

In step (300), if step (241) has already been carried out, the mechatronic system (3) summarizes an update of the analysis of the stored data series (i.e., of the dedicated algorithm or model), so as to be able to classify in the future the data sequence that has not allowed the current statistical analysis to converge.

In step (300), if step (270) has already been carried out, the mechatronic system (3) initiates the summarizing of an update of the analysis of the stored data series (i.e., of the dedicated algorithm or model), so as to be able to classify in the future the data sequence with the highest confidence level compared to what was just calculated.

Steps (260) and (300) then lead to step (280) corresponding to the end of the algorithm for malfunction identification.

Note that the consolidation strategy can be handled by the algorithm for malfunction identification presented here or can be an alternative algorithm, potentially specific to the consolidation code transferred to the DCU (8), proposed by the system or imposed by the DCU (8). The DCU (8) may have preferential responsibility for the strategy to be adopted to consolidate the information (that is the sporadic error or good working order code).

The malfunction identification algorithm described herein is for illustrative purposes only and should in no way be regarded as limiting the scope of the disclosure. The skilled person can easily imagine alternatives varying in similarity that meet the essential technical requirement of informing the DCU (8) of a deviation from nominal operation by means of an error code.

A sequence (300) describing, by way of example, backpropagation applied to a learning model is represented by the flowchart shown in FIG. 5. If in step (301) it is revealed that the previous analysis of the data sequence has diverged instead of converging towards a correct classification of the system among the predetermined options given in FIG. 4, an internal algorithmic analysis step (302) is performed by the control circuit (11) (or by the vehicle DCU (8)) in order to propose an update of the model (that is algorithm) used to perform the analysis of the data sequence. In step (303), if an update can be proposed to classify this sequence of data, while guaranteeing the same levels of performance as the classifications of the previous samples, then a request for an official update can be sent to the vehicle DCU in step (307), and if approved, stored and activated in the MCU in step (308). If, however, no update solution can be identified in steps (302) and (303), then the environmental context wherein the diagnosis was carried out is stored, in a step (304), in the non-volatile memory of the control circuit (11) (or the vehicle DCU (8)) to enable the limitations of the current solution to be identified afterward, this step completing the sequence.

If in step (301) it is revealed that the previous analysis of the data sequence has generated a classification with a confidence level of less than 99.99%, an internal algorithmic analysis loop is initiated by the control circuit (11) (or by the DCU (8) of the vehicle), in a step (305), in order to propose an update of the model (that is of the algorithm) used to perform the analysis of the data sequence. In step (306), if an update can be proposed to generate the classification with a confidence level greater than 99.99% while guaranteeing the same confidence levels o as the classifications of the previous samples, then a request for an official update can be sent to the vehicle DCU (8) in step (307), and if approved, stored and activated in the control circuit (11) in a step (308). If no update solution could be proposed in step (306), the sequence is terminated.

### Different Types of Malfunctions

FIG. 6 shows an example of an active air flow regulation system (1) whose obstructing mechanical member (2) consists of a set of shutters. This active air flow regulation system is positioned on the car's grille, in front of the radiator, and comprises a mechatronic system (3) driving a shaft (4) passing through the output gear of the mechatronic system (3). This shaft (4) controls the positioning of the right shutters (23 to 25) and left shutters (26 to 28) via a transmission (19, 29).

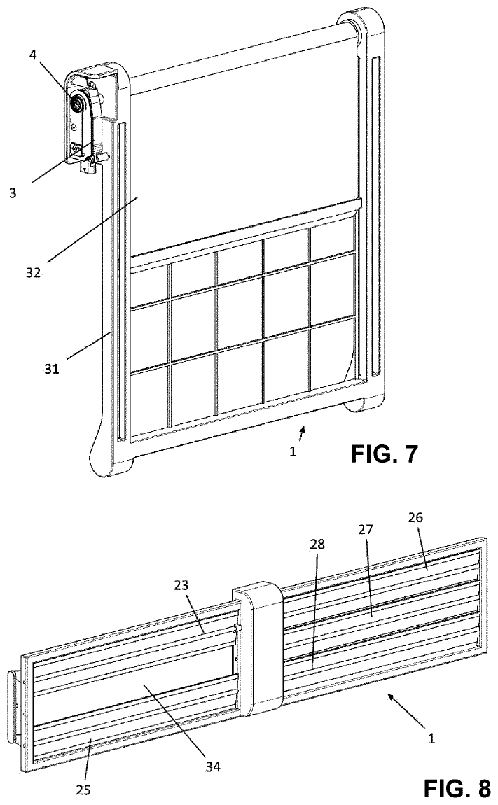

FIG. 7 shows an alternative example of an active air flow regulation system (1) whose obstructing mechanical member (2) consists of a frame (31) that can be closed by a curtain (32) that can be wound around a shaft (4) passing through an output gear of the mechatronic system (3).

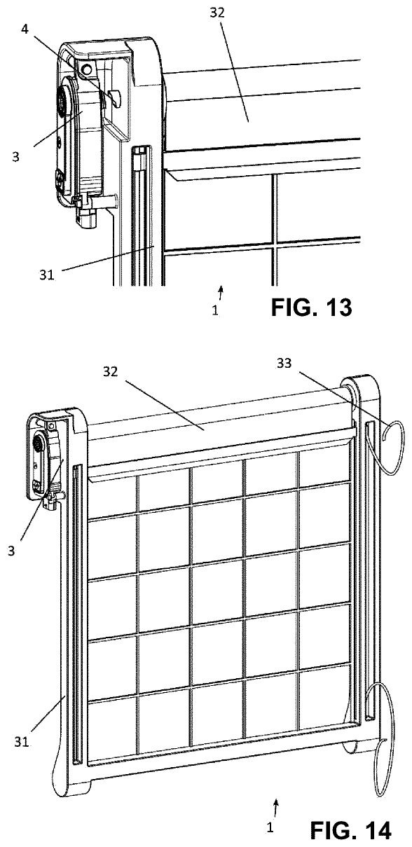

FIGS. 8 to 16 show, in a non-limiting way, different types of malfunctions associated with the active air flow regulation system (1), with FIGS. 8 to 12 showing malfunctions for a mechanical obstructing member (2) fitted with shutters, as shown in FIG. 6, and FIGS. 13 to 16 showing malfunctions for a mechanical obstructing member (2) fitted with a curtain, as shown in FIG. 7. These figures represent systems with active grids whose shutter rotation shafts are positioned horizontally, but the disclosure also extends to any other orientation of the shutter rotation shafts.

FIG. 8 shows a situation where one of the central shutters is missing, due to impact or breakage of its pivot pin. It then gives way to a permanent opening (34) through which air can flow, regardless of the orientation commanded by the actuator. However, the missing shutter (24) will result in a change in the forces exerted on the mechatronic system (3) during the orientation change, and the signature of these forces can be detected by processing the electrical signals directly measured on the power and control ports of the mechatronic system (3). In the example described in FIG. 8, a central shutter is missing, but the disclosure is not limited to this case and different signatures can be observed when an end shutter is missing or even when several shutters are missing, the signature also varying according to the combination of missing shutters.

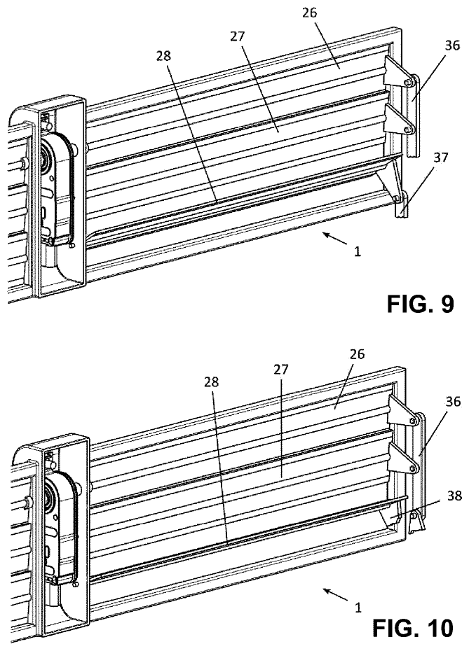

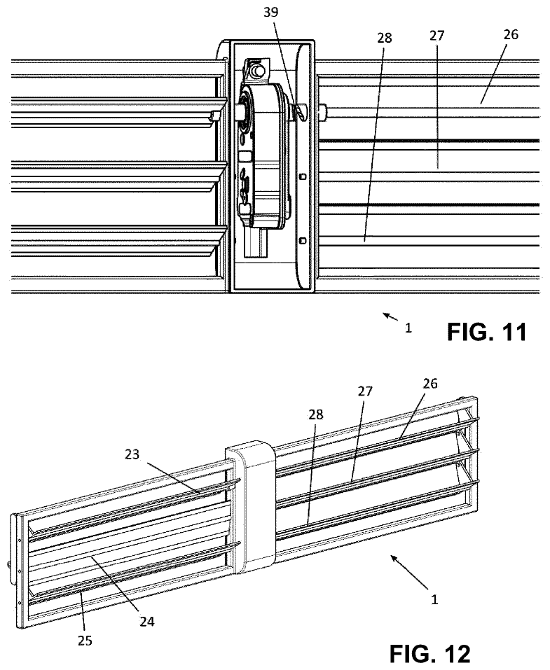

FIGS. 9 to 11 show another malfunction situation on the active shutter air flow regulation system, where all the shutters (26, 27, 28) are present, but one (or more) of them is no longer driven by the motion transmission kinematics (36). This may, for example, be due to the breakage of a connecting rod (37), as shown in FIG. 9, or the breakage of a shutter drive bracket (38) as shown in FIG. 10, or the breakage of the transmission shaft (39) visible in FIG. 11.

This malfunction causes a change in the forces exerted on the mechatronic system (3) during the orientation change. The signature of these forces can be detected by processing the electrical signals directly measured on the power and control ports of the mechatronic system (3).

FIG. 12 shows another malfunction situation, in which a shutter (24) is no longer driven and disturbs the opening or closing of adjacent shutters (23, 25). This behavior can occur when the drive shaft of a shutter breaks and is accompanied by a shift in the stroke of the other shutters. This type of breakage can result in a one-off over-torque required to disengage the shutters in contact, or in a severe over-torque due to the system being completely locked in a position outside the functional stops. It should be noted that seizure of the drive shaft of one or all dampers can also lead to a one-off or general increase in the torque required for the opening or closing stroke.

FIGS. 13 to 15 show another malfunction situation on the active curtain air flow regulation system, where an element in the motion transmission kinematics has failed. This can be caused, for example, by breakage of the drive shaft (4) as shown in FIG. 13, breakage of a drive cable (33) as shown in FIG. 14, or a tear (40) in the curtain (32) as shown in FIG. 15.

This causes a change in the forces exerted on the mechatronic system (3) during the orientation change. The signature of these forces is detected by processing the electrical signals directly measured on the power and control ports of the mechatronic system (3).

FIG. 16 shows another malfunction situation, where the frame (31) of the curtain (32) is deformed or even broken. This type of breakage (35) may result in a one-off over-torque required to move the curtain, or in a severe over-torque due to complete blockage of the system. It should be noted that seizure of the drive shaft of one or all dampers can also lead to a one-off or general increase in the torque required for the opening or closing stroke by the mechatronic system (3).

### Detailed Description of a First Singularity Measurement Variant

In one embodiment, the detection of operating singularities is based on sampling and analysis of the load angle.

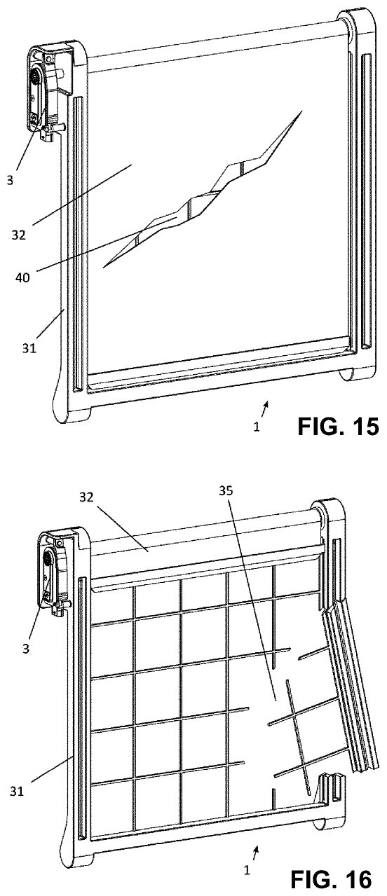

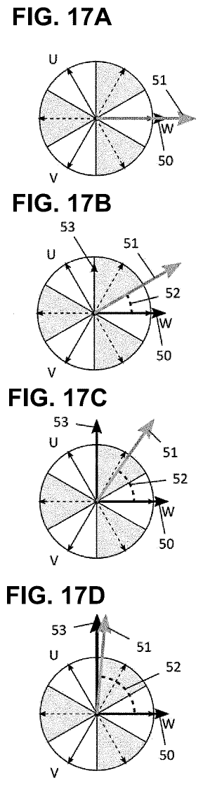

The load angle corresponds to the magnetic angular displacement of the rotor with respect to the angular position canceling the magnetic torque between rotor and stator. A common way of representing this is to use a Fresnel diagram, as shown in FIGS. 17A-17D, wherein the magnetic states of the rotor and stator are represented by vectors. In these figures, representing a three-phase machine, the vectors U, V, W are the magnetic states corresponding to each motor phase being supplied with the same voltage.

In this representation, the load angle (52) corresponds to the angle between the stator vector (50) and the rotor vector (51) of the magnetic field. The resulting torque at rotor level generated by the power supply at stator level varies from zero torque when this angle is equal to 0°, as shown in FIG. 17A, to a maximum when the vectors are at 90°, as shown in FIG. 17D. The torque, represented by the torque vector (53), is directly proportional to the sine of the load angle (52) and the supply current. FIGS. 17B and 17C show intermediate situations where the load angle is between 0° and 90°, in order to visualize the evolution of the torque vector between these values.

Assuming no load on the rotor, the load angle (52) is 0° and the stator and rotor vectors are collinear. The actual angular position of the rotor is identical to the command position.

When a force is applied to the rotor, e.g., braking torque, load or drive torque, the load angle (52) increases and is no longer equal to 0°. When this load angle (52) exceeds 90°, the torque exerted decreases and can lead to a loss of synchronism between the rotor and the stator field, known as rotor stall.

Thus, the measurement of the load angle (52) requires measurement of the rotor angular position.

In its broadest sense, the present disclosure is compatible with all types of synchronous motor control, but this solution is more specifically dedicated to stepper motor control. Various solutions are available to measure rotor position, and the use of dedicated sensors is favored, such as an analog magneto-sensitive probe, which nevertheless has the disadvantage of modest resolution, which can show its limits when measuring very small variations in load angle (52). In actuators with a high mechanical reduction, such as those used in the present disclosure, the reduction chain reduces, by a factor equal to the reduction, the perceptible effects on the drive motor of a variation in load experienced by the member to be driven. Also, because of this reduction, the rotor speed is much greater than that of the driven member, by a factor equal to the reduction. Calculating the rotor angle at each step, or at each microstep, therefore requires a very large and, therefore, expensive computing resource, often incompatible with the target price of these applications. Thus, instead of measuring the load angle by comparing the stator angle with the absolute rotor angle, reconstructed from two signals from an analog quadrature probe, it is proposed to drastically reduce the number of load angle measurements during a complete rotor rotation to improve angular resolution.

A first solution is to continue using an analog probe to measure the field of the sensor magnet, but without the need to reconstruct the absolute rotor angle, which is a source of inaccuracy and consumes computing resources. We then want to measure only the zero crossings of the probe, which are the most accurate because they are where the field variations are greatest. To correctly identify this zero crossing, it is necessary to measure and store the maximum and minimum values of the probe for each magnetic period, the zero crossing then being reconstructed as the mean value between the maximum and minimum values of the previous step. This ensures insensitivity to variations in magnetization amplitude, either slow, irreversible variations due to aging, or reversible, shorter-term variations due, for example, to temperature variations. Measuring the load angle, therefore, involves:
triggering a counter, nₛ, of steps, or microsteps,
stopping the counter when a zero crossing, Z_{c}, of the analog probe is measured, preferentially using the formula

$${Z}_{c} = \frac{{V}_{M} + {V}_{m}}{2} ,$$

V_{M} et Vₘ being respectively the maximum and minimum values of revolution n−1,
storing the maximum and minimum values measured by the analog probe for revolution n,
calculating the load angle L_{A} using the formula

$${L}_{A} = \frac{{n}_{s}}{{n}_{s}} ,$$

where Nₛ is the number of steps or microsteps in a mechanical period.

A second solution is to replace the analog probe with a digital one. This solution slightly degrades the accuracy obtained, as it doesn't allow the transition threshold value to be adjusted for each magnetic period according to the measurements taken during the previous period but offers both a financial saving and a reduction in the computational resources required. By integrating a digital probe, it is possible to use a microcontroller with no analog input, and it is no longer necessary to reconstruct the rotor angle by calculation. The method for measuring the load angle is also similar to the previous solution and consists of:
triggering a step counter, or microstep counter, when a zero-crossing of the digital probe is measured;
stopping the counter when a zero-crossing of the digital probe is measured; and
calculating the load angle L_{A} using the formula

$${L}_{A} = \frac{{n}_{s}}{{n}_{s}} .$$

For both solutions, the load angle measurement over an electrical period, L_{A, 1t}, can be averaged according to the formula

$${L}_{A , 1 t} = {n}_{s 1} + {n}_{s 2} ,$$

nₛ₁ and nₛ₂ being respectively the number of steps counted when the counter is triggered at a predetermined rotor angle

For greater accuracy, the motion can be analyzed over a large number of electrical periods, or even one or more revolutions of the gearbox output shaft. In this case, it is possible to use a sliding average of the load angle over N samples, such as a weighted sliding average, if more weight is to be given to the most recently measured samples:

$${L}_{A , N} ( x ) = \frac{2}{N \times ( N + 1 )} {\sum }_{k = 1}^{N} k \times {L}_{A , 1 t} ( x - k ) ,$$

L_{A, 1t}(x) being the average load angle measurement for the x^{th} electrical revolution and L_{A, 1t}(k) being the load angle measurement for the x^{th} electrical revolution. It should be noted that good results are obtained with a number of samples N between 50 and 100. Of course, other types of sliding averages can be considered, depending on the precision required and the memory and computing resources available.

### Detailed Description of a Second Singularity Measurement Variant

In one embodiment, the detection of operating singularities is based on sampling and analysis of the electrical signal measured at the terminals of an RC filter in series with the power supply of the mechatronic system (3), also known as an actuator, comprising a polyphase motor coupled with a so-called self-commutated control, known to those skilled in the art as “BLDC control” and carried by the electronic module integrated into the mechatronic system (3).

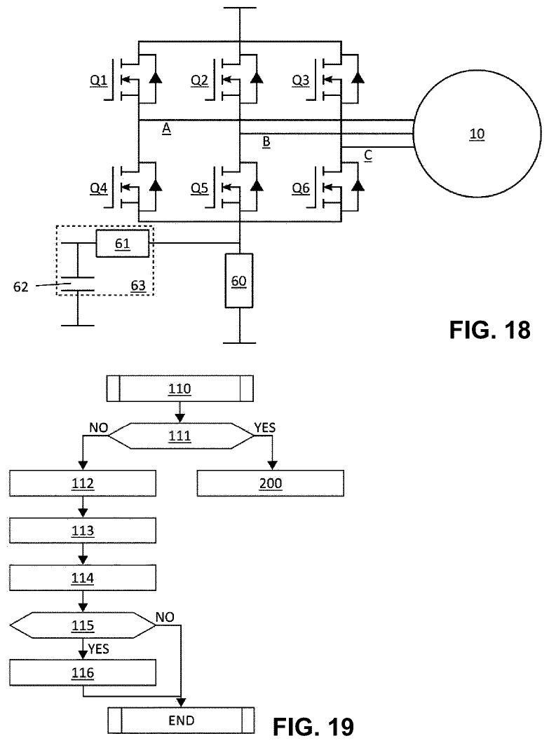

FIG. 18 shows a simplified electrical diagram of a three-phase driver according to the present disclosure, using six transistors Q1 to Q6, Q1 and Q4 (respectively Q2 and Q5, Q3 and Q6) driving the current through phase C (respectively B and A). The resistor (60) is a sampling resistor used to measure the sum of the currents flowing through each phase of the magnet motor (10), via the RC filter (63), consisting of a resistor (61) and a capacitor (62). The output of the RC filter (63) is acquired as a voltage by the analog/digital converter and is continuously transformed and pre-processed into information by a microcontroller, for example.

### Concise Description of Measurement Alternatives for a Singularity

Another parameter that could be interesting to measure in order to detect a fault is the number of steps taken by a motor driven in stepper mode to move from one stop position to another. This type of size is particularly useful for detecting a blocking fault, as the effective stroke can be greatly reduced. In a detailed example, this parameter can also be used to identify a missing shutter.

The measurement of a singularity is not limited to functional quantities in the electric motor, such as current measurement or load angle measurement as presented above but can just as easily come from a dedicated sensor inside the actuator. One example is a pressure or temperature sensor whose variations would be proportional to the incoming air flow. It would, therefore, be quite conceivable to develop different scenarios for making the measurement of these sensors sensitive to the aforementioned faults.

### Description of an Example of a Singularity Identification Algorithm

One means of singularity detection, for example, compatible with the current measurement shown in the description of FIG. 18, is to identify, in the stored data series, a value exceeding the expected value by more than several standard deviations. This is described here using the formalism developed for current measurement but can also be used for other types of measured data. Singularity detection is achieved by digitally processing the evolution of a physical value consisting of the sum of the current I of the N phases of the polyphase motor, measured in the resistor (60). The current has a stable value during nominal operation in synchronous mode, regular and without symptomatic behavior of the rotor of the geared motor, but this value evolves towards a different and more irregular value when the geared motor is subjected to an abnormal or faulty active air flow regulation system (1).

The processing of the variation of the current I measured in the resistor (60) is sampled, using an analog/digital converter of a microcontroller, for example, and the standard deviation o of the amplitude values of the current measured across the resistor (60) over N samples is calculated over a sliding or fixed time window that is less than or equal to the duration of the movement associated with the acquisition of the information.

The characterization of the operating mode and detection of faults is carried out by analyzing the variation of this standard deviation o, possibly supplemented by analysis of the evolution of the median value over N samples of the current measured at the terminals of R1:
A stable standard deviation o, below a threshold value measured during nominal operation, corresponds to trouble-free operation.
An increasing standard deviation exceeding the threshold value and/or a significant increase in the median current measured at the terminals of R1 indicates seizure of one or more shutters and/or their drive mechanism, and hence fluidic control drift.
An increasing standard deviation exceeding the threshold value and/or a significant decrease in the median current measured at the terminals of R1 corresponds to a loss of one or more shutters, being stuck in the open position, or partial destruction of one or more shutters and, therefore, a drift in fluidic control.
As an example, the value N²*σ² is compared with the total current value I of the phases. This digital processing makes it possible to distinguish areas of regular operation from areas of abnormal operation, and to set a standard deviation threshold E, for values N²*σ², above which the microcontroller, or ASIC, decides that the geared motor is driving a faulty gate mechanism. A combination of several other types of algorithmic statistical analysis models can also be used.

### Description of a Variant of a Singularity Identification Algorithm

In one embodiment, the singularity is identified using a learning algorithm, which can be trained to identify the type of error encountered, such as a missing shutter or a broken shutter blocking the system, but can also identify the location of the fault, for example, a missing shutter at one end or in the middle.

If the member to be driven consists of a set of shutters, the fault detection algorithm can benefit from a modification of the member to be driven to improve detection. It is thus envisaged to provide a specific signature for each shutter that can be reliably discriminated by the algorithm. This can be a binary code, as in patent application U.S. Pat. No. 9,810,138B2, with the addition of a point resistive element for each shutter, this resistive element being detectable in the form of a spot over-torque to be generated by the actuator, the point resistive elements being judiciously placed so that each one induces an over-torque at a different instant of the opening or closing stroke. The absence of a shutter is then indicated by the absence of a friction peak during a complete movement of the member to be driven. It should be noted that such a signature can be measured by a very simple algorithm detecting, for example, a current peak consumed by the actuator exceeding a certain threshold at predetermined positions to approve the presence of each shutter.

If the actuator is a set of shutters or a curtain, the signature can be more subtle, taking advantage of the power of deep learning by providing each actuator shutter with a specific surface area, a specific mass, or a specific profile. This can lead to the measurement of a very specific signature linked, for example, to the inertia of the system, to its aeraulic pressure, or even by obtaining a vibration specific to each shutter.

### Description of Other Variants of a Singularity Identification Algorithm

Note that there is a multitude of possible variants of singularity identification algorithms compatible with the disclosure, each with its strengths and weaknesses. For example, some are more robust, but require a certain sequence of actuations of the device to be driven in order to measure a fault; others must be carried out at a standstill, while others must be in motion; still others require the addition of external data such as vehicle speed, wind speed or temperature, so that the solution chosen, or the set of solutions chosen, is defined by the specifications. Some examples of identification algorithms are given below.

According to one variant of the disclosure, the singularity identification algorithm is based on a measurement of hydrodynamic torque variation. When a shutter is missing or the curtain is torn, the pressure exerted on the entire blackout system decreases, resulting in a reduction in the torque required by the actuator to perform an opening or closing movement. The hydrodynamic torque, T_{d}, can be expressed as a function of the actuator stroke, x, according to the formula:

$${T}_{d} ( x ) = {c}_{1} \times ( 1 - {( \frac{A ( x )}{{A}_{m ax}} )}^{2} ) ,$$

where c₁ is a coefficient linked to the geometry of the shading device and the inlet air flow, Aₘₐₓ is the maximum opening area and A(x) the opening area for stroke x, this area being expressed differently for a healthy or broken actuator.

The algorithm can then directly exploit a measurement of torque, current or load angle, as a sequence of sampled digital data, so as to identify a singularity or can, to increase its accuracy, acquire this data along the actuator stroke, so as to identify a singularity on the work, W(x₀, x₁), supplied by the actuator during the movement between e x₀ and x₁ according to the formula:

$$W ( {x}_{0} , {x}_{1} ) = {\int }_{{x}_{0}}^{{x}_{1}} T ( x ) dx$$

The measured work can then simply be compared with a reference curve corresponding to a healthy actuator. It should be noted that this method consumes very few computational resources but is highly dependent on wind and vehicle speed. However, if the available computing power allows a more intelligent algorithm to be implemented, several specific actuator movements can be made to estimate the relative speed of the air impinging on the blackout device.

According to another variant of the disclosure, when the blackout system is a set of shutters, the singularity identification algorithm can be based on a measurement of the system stiffness.

According to another variant of the disclosure, the singularity identification algorithm can be based on a measurement of the system's inertia. If the AGS actuator is controlled so that the angular velocity of the actuator rotor increases linearly between two instants, then the rotor acceleration is constant. By performing an opening cycle with the vehicle stationary, a fault, such as a missing shutter, can be detected by measuring a variation in inertia during this cycle compared with the reference value stored in the system. Alternatively, this variation in inertia could be measured from a torque, current or load angle reading, although these examples are not limitative of the disclosure.

### Detailed Description of a Learning Algorithm Variant

In one embodiment, the algorithm describing malfunction detection diagnostics requires an initial supervised learning phase fed with a set number of cycles, with the system in a nominal (or functional) mode only. One example of such a supervised learning algorithm is shown in the flow chart in FIG. 19.

We denote the number of learning cycles X required to provide a result, for the entire duration of the classification system's use of the sampled acquisition of the & data series of interest, with the optimal confidence rate. The confidence rate is a variable that increases as a function of X, growing rapidly as a function of X and then changing only slightly beyond a certain value of X. It is, therefore, possible to obtain a confidence rate close to 100%, with 100% meaning total certainty and 0% meaning total uncertainty, with a limited number of learning cycles, e.g., 10 or 20 depending on the sensitivity of the algorithm, and for a desired high confidence level of over 99%.

The learning algorithm (100) is triggered each time the actuator is set in motion by the control circuit (11), which we call step (110), followed by a step (111) to check that the initial learning phase has been completed, which can be done by reading a memory register. If the learning phase has already been successfully completed, the learning algorithm terminates and triggers the fault detection algorithm (200).

If, on the other hand, the learning phase is not deemed to have been completed, the “non-operational” status of the malfunction detection system is generated by the mechatronic system (3) for the DCU (8) in a step (112). Movement is then initiated by the mechatronic system (3). The step (113) of the learning algorithm consists in a sampled acquisition of the data of interest by the control circuit (11) and in storing these data in the internal memory of the mechatronic system (3). Step (113) is completed when the end of actuator movement is detected. The learning algorithm then triggers, in step (114), the statistical analysis of the data stored for this learning cycle in step (113). The next step (115) consists of a check by the control circuit (11) of the correctness of the movement performed by the actuator and of the correct environmental conditions (that is the correct context), leading to the decision whether or not to keep the data from the current cycle as reference data for the learning algorithm. If kept, these data are stored as reference data in a memory register in a final step (116). The reference data storing preferentially includes contextual data from the stored cycle, such as information on temperature, vehicle speed, air pressure at the shutters, etc., which may come from external sensors, with associated information then potentially being generated by the mechatronic system (3) to the DCU (8). If the check concludes that the data is inadequate, the data is not stored, so the cycle is not considered a reference cycle, and information can be generated by the mechatronic system (3) to inform the DCU (8).

Embodiment where Data Processing is Shared Between ECU and DCU (8)

In the above description, it is generally envisaged that all algorithmic processing is carried out via the control circuit (11) only, which then transmits information characterizing the nature of the malfunction detected in the air flow chain, with or without a mechanical fault.

However, it is also possible to divide the algorithmic processing between the control circuit (11) and the vehicle's DCU (8), which generally has a much higher computing capacity and which can also optionally take into account other vehicle data in order to achieve more complete integration of the vehicle diagnostics. However, this embodiment must take into account the fact that the transmission BUS between a piece of equipment and the vehicle's DCU has a limited bandwidth and does not allow raw sensor data to be transmitted directly to the vehicle's DCU. The “distributed” embodiment of the disclosure then consists of high-frequency pre-processing of the raw data on the control circuit (11), to calculate pre-processed data sets that are then transmitted, at a frequency compatible with the bandwidth of the communication lines (7), for example, using a LIN protocol, from the control circuit (11) to the vehicle's DCU (8), the latter uses these data sets transmitted at low frequency to carry out post-processing at a second frequency, lower than the first frequency, to enable it to complete the analysis, and identify a sporadic error that then enables the DCU (8) to characterize the aeraulic and/or mechanical failure of the air flow regulation system.

1. A method for diagnosing an operation of an active air flow regulation system for a vehicle, comprising:
an obstructing mechanical member;
a mechatronic system provided with a housing containing a magnet motor driven by a control circuit and coupled to a movement transformation for moving the obstructing mechanical member; and
electronic communication lines for exchanging information with the domain controller unit (DCU) of the vehicle or receiving commands from the DCU of the vehicle,
wherein the method comprises:
storing, during an operating cycle of the active air flow regulation system, a numerical sequence S of data in a memory, the data being acquired by the control circuit inside the mechatronic system;
applying an algorithmic statistical analysis model to the numerical sequence of data S stored in the memory to determine a singularity; and
identifying a sporadic error associated with the singularity to provide information on a state of the active air flow regulation system.

2. The method of claim 1, wherein the identifying of the sporadic error is performed by the control circuit, the control circuit transmitting to the DCU information representative of the identified sporadic error.

3. The method of claim 1, wherein the numerical sequence of digital data stored in the memory is a subject of:
preprocessing with a first processing frequency by the control circuit; and
post-processing by the domain controller unit/electronic control unit (DCU/ECU) of the vehicle with a second processing frequency lower than the first processing frequency, to complete the algorithmic statistical analysis and identify a sporadic error,
a data set pre-processed by the control circuit being transmitted to the DCU/ECU via the electronic communication lines.

4. The method of claim 1, wherein the sequence of digital data S stored in memory comprises:
a. data of a first type; and
b. data of at least a second type different from the first type.

5. The method of claim 1, further comprising:
a. consolidating the sporadic error following an instruction transmitted by the vehicle's DCU, resulting in a consolidated diagnostic status; and
b. transmitting the consolidated diagnostic status to the vehicle's DCU.

6. The method of claim 1, wherein the data is comprises a measurement of a motor phase current.

7. The method of claim 1, wherein the data comprises a measurement of a load angle of a rotor of the magnet motor.

8. The method of claim 1, wherein the algorithmic statistical analysis model comprises a learning sequence.

9. The method of claim 1, wherein the algorithmic statistical analysis model comprises a cluster selection method.

10. The method of claim 1, wherein the obstructing mechanical member is devoid of diagnosis-dedicated elements external to the mechatronic system.

11. The method of claim 1, wherein at least a portion of the data relates to operation of the magnet motor of the mechatronic system.

12. The method of claim 1, wherein the algorithmic model of statistical analysis for determining a singularity comprises a comparison between the stored sequence of sampled digital data S and a reference data map.

13. The method of claim 1, wherein the algorithmic model for statistical analysis to determine a singularity comprises detection of at least one singular point in the stored sequence of sampled digital data.

14. The method of claim 1, wherein the algorithmic model for statistical analysis to determine a singularity comprises subjecting the stored sequence of sampled digital data to a model obtained by training a neural network from training data corresponding to an expected operation of the obstructing mechanical member.

15. The method of claim 1, wherein a reference sequence of sampled digital data is stored for each mechatronic system at an end of an assembly line of the system, or of the system on the vehicle.

16. The method of claim 15, wherein the algorithmic model for statistical analysis is configured to compare the sampled digital data sequence with the reference sequence of sampled digital data so as to detect a behavioral drift that may give rise to a degradation of the mechatronic system or that may validate a normal wear behavior of the system.

17. The method of claim 1, wherein the stored sequence of sampled digital data is derived from digital data dependent on a mechanical load in an active grid system.

18. The method of claim 17, wherein identification of a singularity in the stored sequence of sampled digital data is enabled with knowledge of:
masses or inertia to be moved in the active grid system,
and/or mechanical friction in the system,
and/or an aeraulic load exerted on the system,
and/or system temperature.

19. An electromechanical active air flow regulation system for a vehicle, comprising:
an obstructing mechanical member;
a mechatronic system having a housing containing a magnet motor driven by a control circuit and coupled to a movement transformation for moving the obstructing mechanical member; and
electronic communication lines for exchanging information with the domain controller unit (DCU) of the vehicle or receiving commands from the DCU of the vehicle; and
a microcontroller or microprocessor executing a computer program stored in its read-only memory, controlling the system so as to perform a method according to claim 1.
